(19) United States
(12) Patent Application Publication
(10) Pub. No.: US 2016/0355720 A1
(43) Pub. Date: Dec. 8, 2016

(54) THERMAL STORAGE MATERIAL CONTAINING HEXANARY COMPOSITION

(71) Applicant: KOREA INSTITUTE OF ENERGY RESEARCH, Daejeon (KR)

(72) Inventors: Hong-Soo Kim, Daejeon (KR); Si-Kyoung Kim, Daejeon (KR); Kang Bai, Seoul (KR); Jong-Kyu Kim, Daejeon (KR); Yong-Heack Kang, Daejeon (KR)

(73) Assignee: Korea Institute of Energy Research, Daejeon (KR)

(21) Appl. No.: 15/037,611

(22) PCT Filed: Nov. 12, 2014
(86) PCT No.: PCT/KR14/10832

§ 371 Date: Aug. 29, 2016

(30) Foreign Application Priority Data
Nov. 19, 2013 (KR) 10-2013-0140627

(51) Int. Cl. C09K 5/12

(52) U.S. Cl. CPC C09K 5/12

(57) ABSTRACT

The present disclosure relates to a thermal storage material containing a hexanary composition of NaNO₃—NaNO₂—KNO₃—KNO₂—Ca(NO₃)₂—LiNO₃ for lowering a melting point of molten salts.

### FIELD OF THE INVENTION

The present disclosure relates to a material storing heat obtained during the day so that a concentrating solar power (CSP) facility continues power generation after sunset or in a cloudy day, and in particular, to a thermal storage material including an inorganic salt mixture formed with nitrates and nitrites. The thermal storage material of the present disclosure has low melting and freezing points, and even when the whole system will not be able to absorb heat, the liquid thermal storage material will not be frozen between a thermal storage system and a thermal absorption facility.

### BACKGROUND OF THE INVENTION

Fossil fuel such as coal or petroleum is convenient to use, but emits greenhouse gas such as carbon dioxide after use, and also has limited deposits, and therefore, has a limit in the use as a future energy source. Meanwhile, compared to fossil fuel, solar energy is capable of being used for a very long period of time, and has no environmental obstacles such as greenhouse gas or noises, and accordingly, has received attention as a future energy source.

Among solar energy, technologies using the rays of the sun represented by solar cells have a long history and are also matured technologies, however, the technologies are not suitable in regions of high temperature environments such as deserts due to rapidly decreased efficiency. Concentrating solar power is an alternative capable of solving such a problem, and is a method of making superheated steam with a high temperature obtained by gathering sunlight using a great number of mirrors, and generating power using this steam.

Concentrating solar power does not produce any kind of contamination during a sunlight gathering process, and superheated steam made using the obtained high temperature generates power using a steam engine and the like, which is an already matured technology. However, superheated steam is capable of being produced during the day when the sun is out since a high temperature is obtained, but has a disadvantage of generating power for only approximately 8 hours a day since a high temperature is not obtained after sunset.

When storing some of the heat obtained from a high temperature during a sunlight gathering process in a thermal storage material, superheated steam may be produced and power may be continuously generated by heat exchange with the thermal storage material without sun. A traditional thermal storage material is a salt mixing sodium nitrate and potassium nitrate and when using a composition of 60:40 in a weight ratio, the material becomes liquid at 220° C., and may be stably used up to 550° C.

Molten salts formed with nitrate compounds become solid at 220° C. or lower, and therefore, are not able to be used as a heat transfer fluid circulating between a solar power system and a thermal storage system. Organic synthetic oil is generally used as a heat transfer fluid, but has disadvantages in that a heat exchanger is additionally required between a heat storage fluid and a heat transfer fluid, and thermal storage at 400° C. or higher is not achieved since organic synthetic oil is stable up to 400° C.

In order to lower melting points of molten salts, a trade name of HITEC using a ternary composition of NaNO₃—NaNO₂—KNO₃ has been in the market besides a binary composition of NaNO₃—KNO₃ used in the art, however, a freezing point thereof is still high of 142° C. If a freezing point of a molten salt thermal storage material is significantly lowered so that the thermal storage material is not frozen in a pipe and remains liquefied while heat is not obtained from the sun such as during the night, thermal storage may be achieved at low costs without using expensive organic synthetic oil.

Melting points and freezing points of compositions generally go down when mixing materials having similar crystal structures. Melting points of specific compositions may be found out from phase equilibrium diagrams, and compositions formed with nitrates and nitrites may be binary compositions such as NaNO₃—KNO₃, NaNO₃—LiNO₃ and KNO₃—LiNO₃, and ternary compositions such as NaNO₃—KNO₃—LiNO₃ and NaNO₃—NaNO₂—KNO₃, and many phase equilibrium diagrams thereof are provided, however, phase equilibrium diagrams of quaternary or higher compositions are difficult to find, and many experiments need to be carried out for identification.

U.S. Pat. No. 7,588,694 prepares a quaternary composition of NaNO₃—KNO₃—LiNO₃—Ca(NO₃)₂ and makes the melting point to 100° C. or lower. In addition, in another related art, a molten salt having a melting point of 80° C. has been made using a pentanary composition of LiNO₃—NaNO₃—KNO₃—NaNO₂—KNO₂, and a molten salt having a melting point of 70° C. has been made using a quaternary composition of LiNO₃—KNO₃—NaNO₂—KNO₂. In addition, a molten salt having a melting point of 70° C. using a pentanary composition of LiNO₃—NaNO₃—KNO₃—NaNO₂—KNO₂ has also been studied. However, hexanary compositions simultaneously adding NaNO₂, KNO₂ and Ca(NO₃)₂ have not been studied, and lower melting points are still required.

In addition, high thermal capacity is required to be used as a thermal storage material, and therefore, thermal capacity of a thermal storage material needs to be enhanced.

Accordingly, the present disclosure intends to further lower a melting point by including a hexanary composition of NaNO₃—KNO₃—LiNO₃—NaNO₂—KNO₂—Ca(NO₃)₂.

### SUMMARY OF THE INVENTION

The present disclosure is directed to providing a thermal storage material including a hexanary composition of NaNO₃—NaNO₂—KNO₃—KNO₂—Ca(NO₃)₂—LiNO₃ by adding Ca(NO₃)₂ to a pentanary composition of LiNO₃—NaNO₃—KNO₃—NaNO₂—KNO₂ for lowering a melting point of molten salts.

The present disclosure is also directed to providing a thermal storage material having high thermal capacity.

An aspect of the present disclosure provides a thermal storage material including NaNO₃—NaNO₂—KNO₃—KNO₂—Ca(NO₃)₂—LiNO₃ for lowering a melting point and increasing thermal capacity.

Preferably, the Ca(NO₃)₂ is from 0.05 mol % to 0.1 mol %.

Preferably, the NaNO₃ is from 0.1 mol % to 0.2 mol %, the Ca(NO₃)₂ is from 0.05 mol % to 0.4 mol % and the LiNO₃ is from 0.05 mol % to 0.5 mol %.

Preferably, the NaNO₂ is from 0.1 mol % to 0.2 mol %, the Ca(NO₃)₂ is from 0.05 mol % to 0.4 mol % and the LiNO₃ is from 0.05 mol % to 0.5 mol %.

Preferably, the KNO₃ is from 0.1 mol % to 0.2 mol %, the Ca(NO₃)₂ is from 0.05 mol % to 0.4 mol % and the LiNO₃ is from 0.05 mol % to 0.5 mol %.

Preferably, the KNO₂ is from 0.1 mol % to 0.2 mol %, the Ca(NO₃)₂ is from 0.05 mol % to 0.4 mol % and the LiNO₃ is from 0.05 mol % to 0.5 mol %.

Preferably, a molar ratio of the NaNO₃:NaNO₂:KNO₃:KNO₂:Ca(NO₃)₂:LiNO₃ is 1:1:1:1:0.2 to 0.5:0.8 to 2.2.

Preferably, a sum of the Ca(NO₃)₂ and the LiNO₃ is from 1.3 mol to 2.7 mol with respect to 1 mol of the NaNO₃.

Preferably, as the thermal storage material including a hexanary composition of NaNO₃—NaNO₂—KNO₃—KNO₂—Ca(NO₃)₂—LiNO₃, the thermal storage material includes 0.16 mol % to 0.17 mol % of the NaNO₃, 0.16 mol % to 0.17 mol % of the NaNO₂, 0.16 mol % to 0.17 mol % of the KNO₃, 0.16 mol % to 0.17 mol % of the KNO₂, 0.03 mol % to 0.07 mol % of the Ca(NO₃)₂ and 0.28 mol % to 0.32 mol % of the LiNO₃;

0.17 mol % to 0.18 mol % of the NaNO₃, 0.17 mol % to 0.18 mol % of the NaNO₂, 0.17 mol % to 0.18 mol % of the KNO₃, 0.17 mol % to 0.18 mol % of the KNO₂, 0.03 mol % to 0.07 mol % of the Ca(NO₃)₂ and 0.23 mol % to 0.27 mol % of the LiNO₃;

0.16 mol % to 0.17 mol % of the NaNO₃, 0.16 mol % to 0.17 mol % of the NaNO₂, 0.16 mol % to 0.17 mol % of the KNO₃, 0.16 mol % to 0.17 mol % of the KNO₂, 0.08 mol % to 0.12 mol % of the Ca(NO₃)₂ and 0.23 mol % to 0.27 mol % of the LiNO₃; 0.14 mol % to 0.16 mol % of the NaNO₃, 0.14 mol % to 0.16 mol % of the NaNO₂, 0.14 mol % to 0.16 mol % of the KNO₃, 0.14 mol % to 0.16 mol % of the KNO₂, 0.18 mol % to 0.22 mol % of the Ca(NO₃)₂ and 0.18 mol % to 0.22 mol % of the LiNO₃; or 0.16 mol % to 0.17 mol % of the NaNO₃, 0.16 mol % to 0.17 mol % of the NaNO₂, 0.16 mol % to 0.17 mol % of the KNO₃, 0.16 mol % to 0.17 mol % of the KNO₂, 0.18 mol % to 0.22 mol % of the Ca(NO₃)₂ and 0.13 mol % to 0.17 mol % of the LiNO₃, and when the substances are included in the above-mentioned content, the thermal storage material is capable of having a lower freezing point.

Another aspect of the present disclosure provides a solar heat storage system provided with the thermal storage material including NaNO₃—NaNO₂—KNO₃—KNO₂—Ca(NO₃)₂—LiNO₃.

### Advantageous Effects

A thermal storage material including a hexanary composition of the present disclosure is capable of lowering a melting point or a freezing point of the molten salt thermal storage material to 45° C. by lowering an eutectic temperature formed thereby.

By lowering a freezing point of the inorganic molten salt, the molten salt composition can be used as a heat transfer fluid as well as a thermal storage material.

### BRIEF DESCRIPTION OF THE DRAWINGS

FIG. 1 shows differential scanning calorimeter (DSC) measurement results on Composition 6-9 prepared in Example 1.

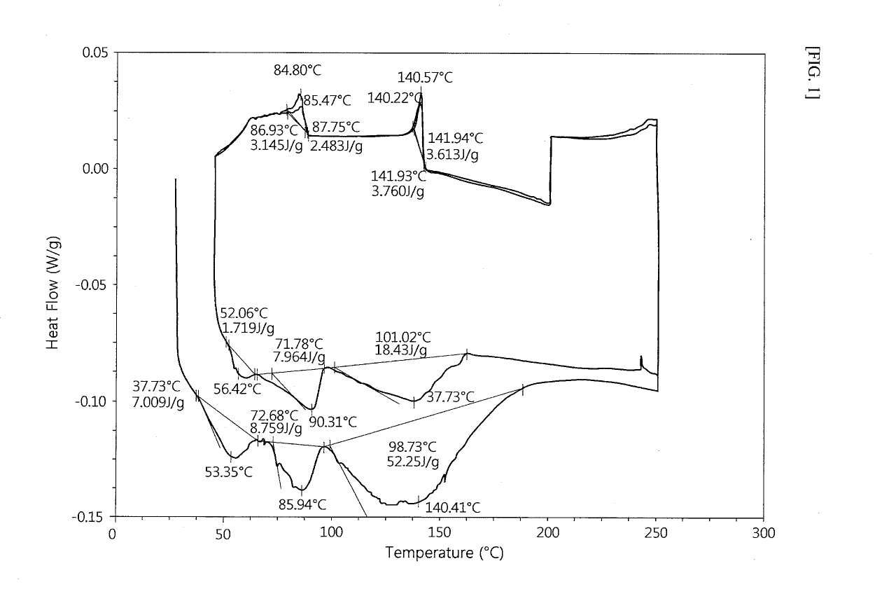

### DETAILED DESCRIPTION OF THE EMBODIMENTS

The present disclosure provides a thermal storage material including a hexanary composition of NaNO₃—NaNO₂—KNO₃—KNO₂—Ca(NO₃)₂—LiNO₃. The hexanary composition as in the present disclosure has an advantage of further lowering a melting point of a molten salt thermal storage material compared to existing binary to pentanary compositions.

When a freezing point of a molten salt decreases, the molten salt composition may be used as a heat transfer fluid as well as a thermal storage material, and accordingly, a heat exchanger required when using organic synthetic oil as a heat transfer fluid is not required. In addition, heat storage efficiency may be greatly enhanced since a working temperature of an inorganic molten salt to be used as a heat transfer fluid reaches 550° C.

Accordingly, as the thermal storage material including a hexanary composition of the present disclosure has a low melting point, and the thermal storage material has advantages of being not frozen and being kept liquefied even when the thermal storage material does not receive heat from the sun such as during the night.

In the hexanary composition of the present disclosure, the Ca(NO₃)₂ is preferably from 0.05 mol % to 0.1 mol %.

Preferably, the NaNO₃ is from 0.1 mol % to 0.2 mol %, the Ca(NO₃)₂ is from 0.05 mol % to 0.4 mol % and the LiNO₃ is from 0.05 mol % to 0.5 mol %.

Preferably, the NaNO₂ is from 0.1 mol % to 0.2 mol %, the Ca(NO₃)₂ is from 0.05 mol % to 0.4 mol % and the LiNO₃ is from 0.05 mol % to 0.5 mol %.

Preferably, the KNO₃ is from 0.1 mol % to 0.2 mol %, the Ca(NO₃)₂ is from 0.05 mol % to 0.4 mol % and the LiNO₃ is from 0.05 mol % to 0.5 mol %.

Preferably, the KNO₂ is from 0.1 mol % to 0.2 mol %, the Ca(NO₃)₂ is from 0.05 mol % to 0.4 mol % and the LiNO₃ is from 0.05 mol % to 0.5 mol %.

Preferably, a molar ratio of the NaNO₃:NaNO₂:KNO₃:KNO₂:Ca(NO₃)₂:LiNO₃ is 1:1:1:1:0.2 to 0.5:0.8 to 2.2.

Preferably, a sum of the Ca(NO₃)₂ and the LiNO₃ is from 1.3 mol to 2.7 mol with respect to 1 mol of the NaNO₃.

In addition, the present disclosure provides a solar heat storage system provided with the thermal storage material including NaNO₃—NaNO₂—KNO₃—KNO₂—Ca(NO₃)₂—LiNO₃.

Hereinafter, the present disclosure will be described in more detail with reference to examples. However, the following examples are for illustrative purposes only, and the scope of the present disclosure is not limited to the following examples.

### Example and Comparative Example

### EXAMPLE

### Preparation of Hexanary Composition

As reagents to prepare a hexanary composition, NaNO₃ (Kanto, 99.9%), NaNO₂ (Kanto 98.5%), KNO₃ (Kanto, 99.0%), KNO₂ (Aldrich, 96%), LiNO₃ (Kanto GR), Ca(NO₃)₂·4H₂O (Aldrich, 99%) were used, and the Ca(NO₃)₂·4H₂O was made to Ca(NO₃)₂ by being heated for 4 hours at 500° C. and then used.

### Example 1

TABLE 1

| Sample | (NaNO₃)₂ | (NaNO₂)₂ | (KNO₃)₂ | (KNO₂)₂ | Ca(NO₃)₂ | (LiNO₃)₂ |
|---|---|---|---|---|---|---|
| 6-6 | 0.1500 | 0.1500 | 0.1500 | 0.1500 | 0.0500 | 0.3500 |
| 6-7 | 0.1625 | 0.1625 | 0.1625 | 0.1625 | 0.0500 | 0.3000 |
| 6-8 | 0.1750 | 0.1750 | 0.1750 | 0.1750 | 0.0500 | 0.2500 |
| 6-9 | 0.1875 | 0.1875 | 0.1875 | 0.1875 | 0.0500 | 0.2000 |

(mol %)

After mixing 70 g of raw material powder in molar ratios of (6-6) to (6-9), the result was placed in a nickel crucible, melted by heating for 1 hour at 300° C., and then taken out at 200° C.

The coagulated molten salt composition was ground in an alumina mortar, and then the melting point and the freezing point were measured using a differential scanning calorimeter (DSC). The melting point and the freezing point of each of the compositions are shown in the tables, and when multiple melting points and freezing points are present, the temperatures are all listed. The melting point measured using a DSC was the lowest of 49.0° C. when the (LiNO₃)₂ composition was 0.35 mol %, and the freezing point was 49.8° C.

TABLE 2

| | Melting | Melting | Melting | Freezing | Freezing | Freezing |
|---|---|---|---|---|---|---|
| Sample | Point 1 | Point 2 | Point 3 | Point 1 | Point 2 | Point 3 |
| 6-6 | 49.0 | 79.3 | 92.3 | 142.6 | 49.8 | N/A |
| 6-7 | 69.3 | N/A | N/A | 143.0 | 54.2 | N/A |
| 6-8 | 71.0 | N/A | N/A | 144.3 | 78.6 | N/A |
| 6-9 | 52.1 | 72.0 | 101.1 | 141.9 | 86.9 | N/A |

(° C.)

### Example 2

TABLE 3

| Sample | (NaNO₃)₂ | (NaNO₂)₂ | (KNO₃)₂ | (KNO₂)₂ | Ca(NO₃)₂ | (LiNO₃)₂ |
|---|---|---|---|---|---|---|
| 6-10 | 0.1500 | 0.1500 | 0.1500 | 0.1500 | 0.1000 | 0.3000 |
| 6-11 | 0.1625 | 0.1625 | 0.1625 | 0.1625 | 0.1000 | 0.2500 |
| 6-12 | 0.1750 | 0.1750 | 0.1750 | 0.1750 | 0.1000 | 0.2000 |
| 6-13 | 0.1875 | 0.1875 | 0.1875 | 0.1875 | 0.1000 | 0.1500 |

(mol %)

After mixing 70 g of raw material powder in molar ratios of (6-10) to (6-13), the result was placed in a nickel crucible, melted by heating for 1 hour at 300° C., and then taken out at 200° C.

The coagulated molten salt composition was ground in an alumina mortar, and then the melting point and the freezing point were measured using a differential scanning calorimeter (DSC). The melting point measured using a DSC was the lowest of 50.9° C. when the (LiNO3)2 composition was 0.15 mol %, and the freezing point was 113.0° C.

TABLE 4

| | Melting | Melting | Melting | Melting | Freezing | Freezing | Freezing |
|---|---|---|---|---|---|---|---|
| Sample | Point 1 | Point 2 | Point 3 | Point 4 | Point 1 | Point 2 | Point 3 |
| 6-10 | 65.7 | 161.0 | N/A | N/A | 159.4 | 65.4 | N/A |
| 6-11 | 63.8 | N/A | N/A | N/A | 154.8 | 80.8 | N/A |
| 6-12 | 86.7 | 117.4 | N/A | N/A | 157.8 | 100.0 | N/A |
| 6-13 | 50.9 | 90.6 | 100.2 | 123.6 | 149.5 | 113.0 | N/A |

(° C.)

### Example 3

TABLE 5

| Sample | (NaNO₃)₂ | (NaNO₂)₂ | (KNO₃)₂ | (KNO₂)₂ | Ca(NO₃)₂ | (LiNO₃)₂ |
|---|---|---|---|---|---|---|
| 6-14 | 0.1500 | 0.1500 | 0.1500 | 0.1500 | 0.1500 | 0.2500 |
| 6-15 | 0.1625 | 0.1625 | 0.1625 | 0.1625 | 0.1500 | 0.2000 |
| 6-16 | 0.1750 | 0.1750 | 0.1750 | 0.1750 | 0.1500 | 0.1500 |
| 6-17 | 0.1875 | 0.1875 | 0.1875 | 0.1875 | 0.1500 | 0.1000 |

(mol %)

After mixing 70 g of raw material powder in molar ratios of (6-14) to (6-17), the result was placed in a nickel crucible, melted by heating for 1 hour at 300° C., and then taken out at 200° C.

The coagulated molten salt composition was ground in an alumina mortar, and then the melting point and the freezing point were measured using a differential scanning calorimeter (DSC). The melting point measured using a DSC was the lowest of 73.9° C. when the (LiNO₃)₂ composition was 0.2 mol %, and the freezing point was 68.0° C. When the (LiNO₃)₂ composition was 0.25 mol %, the melting point was the lowest of 50.0° C., however, the freezing point was rather high of 152.8° C.

TABLE 6

| | Melting | Melting | Melting | Melting | Freezing | Freezing | Freezing |
|---|---|---|---|---|---|---|---|
| Sample | Point 1 | Point 2 | Point 3 | Point 4 | Point 1 | Point 2 | Point 3 |
| 6-14 | 50.0 | 103.8 | N/A | N/A | 152.8 | N/A | N/A |
| 6-15 | 73.9 | 149.5 | N/A | N/A | 151.2 | 68.0 | N/A |
| 6-16 | 76.1 | 107.0 | N/A | N/A | 149.8 | 89.7 | N/A |
| 6-17 | 59.5 | 81.4 | 99.6 | 125.1 | 147.9 | 111.8 | 82.2 |

(° C.)

### Example 4

TABLE 7

| Sample | (NaNO₃)₂ | (NaNO₂)₂ | (KNO₃)₂ | (KNO₂)₂ | Ca(NO₃)₂ | (LiNO₃)₂ |
|---|---|---|---|---|---|---|
| 6-18 | 0.1500 | 0.1500 | 0.1500 | 0.1500 | 0.2000 | 0.2000 |
| 6-19 | 0.1625 | 0.1625 | 0.1625 | 0.1625 | 0.2000 | 0.1500 |
| 6-20 | 0.1750 | 0.1750 | 0.1750 | 0.1750 | 0.2000 | 0.1000 |
| 6-21 | 0.1875 | 0.1875 | 0.1875 | 0.1875 | 0.2000 | 0.0500 |

(mol %)

After mixing 70 g of raw material powder in molar ratios of (6-18) to (6-21), the result was placed in a nickel crucible, melted by heating for 1 hour at 300° C., and then taken out at 200° C.

The coagulated molten salt composition was ground in an alumina mortar, and then the melting point and the freezing point were measured using a differential scanning calorimeter (DSC). The melting point measured using a DSC was the lowest of 57.8° C. when the (LiNO₃)₂ composition was 0.2 mol %, however, the freezing point was 150.7° C.

TABLE 8

| | Melting | Melting | Melting | Melting | Freezing | Freezing | Freezing |
|---|---|---|---|---|---|---|---|
| Sample | Point 1 | Point 2 | Point 3 | Point 4 | Point 1 | Point 2 | Point 3 |
| 6-18 | 57.8 | N/A | N/A | N/A | 150.7 | N/A | N/A |
| 6-19 | 67.9 | N/A | N/A | N/A | 154.1 | N/A | N/A |
| 6-20 | 88.0 | 104.1 | 115.3 | N/A | 153.1 | 93.6 | N/A |
| 6-21 | 84.9 | 99.1 | 134.2 | N/A | 151.2 | 123.3 | N/A |

(° C.)

### Example 5

TABLE 9

| Sample | (NaNO₃)₂ | (NaNO₂)₂ | (KNO₃)₂ | (KNO₂)₂ | Ca(NO₃)₂ | (LiNO₃)₂ |
|---|---|---|---|---|---|---|
| 6-22 | 0.1500 | 0.1500 | 0.1500 | 0.1500 | 0.2500 | 0.1500 |
| 6-23 | 0.1625 | 0.1625 | 0.1625 | 0.1625 | 0.2500 | 0.1000 |

(mol %)

After mixing 70 g of raw material powder in molar ratios of (6-22) and (6-23), the result was placed in a nickel crucible, melted by heating for 1 hour at 300° C., and then taken out at 200° C.

The coagulated molten salt composition was ground in an alumina mortar, and then the melting point and the freezing point were measured using a differential scanning calorimeter (DSC). The melting point measured using a DSC was the lowest of 61.9° C. when the (LiNO₃)₂ composition was 0.15 mol %, however, the freezing point was 155.7° C.

TABLE 10

| | Melting | Melting | Melting | Melting | Freezing | Freezing | Freezing |
|---|---|---|---|---|---|---|---|
| Sample | Point 1 | Point 2 | Point 3 | Point 4 | Point 1 | Point 2 | Point 3 |
| 6-22 | 61.9 | 115.5 | N/A | N/A | 155.7 | N/A | N/A |
| 6-23 | 63.7 | 96.0 | 107.8 | 124.1 | 160.4 | 85.0 | N/A |

(° C.)

### Example 6

TABLE 11

| Sample | (NaNO₃)₂ | (NaNO₂)₂ | (KNO₃)₂ | (KNO₂)₂ | Ca(NO₃)₂ | (LiNO₃)₂ |
|---|---|---|---|---|---|---|
| 6-24 | 0.1375 | 0.1375 | 0.1375 | 0.1375 | 0.0500 | 0.4000 |
| 6-25 | 0.1375 | 0.1375 | 0.1375 | 0.1375 | 0.1000 | 0.3500 |

(mol %)

After mixing 70 g of raw material powder in molar ratios of (6-24) and (6-25), the result was placed in a nickel crucible, melted by heating for 1 hour at 300° C., and then taken out at 200° C.

The coagulated molten salt composition was ground in an alumina mortar, and then the melting point and the freezing point were measured using a differential scanning calorimeter (DSC). The melting point measured using a DSC was the lowest of 62.2° C. when the (LiNO₃)₂ composition was 0.40 mol %, and the freezing point was 63.1° C., which was the lowest.

TABLE 12

| | Melting | Melting | Melting | Melting | Freezing | Freezing | Freezing |
|---|---|---|---|---|---|---|---|
| Sample | Point 1 | Point 2 | Point 3 | Point 4 | Point 1 | Point 2 | Point 3 |
| 6-24 | 62.2 | 91.1 | N/A | N/A | 139.1 | 63.1 | N/A |
| 6-25 | 72.4 | 93.2 | N/A | N/A | 144.6 | N/A | N/A |

(° C.)

### Comparative Example 1

### Preparation of Binary Composition

50 g of a solar salt composition was made by mixing 60 wt % of NaNO₃ and 40 wt % of KNO3, and the composition was heated for 1 hour at 400° C. after being placed in a nickel crucible. The composition hardened after being taken out from an electric furnace was ground using an alumina mortar, and then the melting point and the freezing point were measured using a DSC.

TABLE 13

| | Melting | Melting | Freezing | Freezing |
|---|---|---|---|---|
| | Point 1 | Point 2 | Point 1 | Point 2 |
| Solar Salt | 107.5 | 220.4 | 234.6 | 225.5 |

(° C.)

### Comparative Example 2

### Preparation of Ternary Composition

50 g of a HITEC composition was made by mixing 7 wt % of NaNO₃, 53 wt % of KNO₃ and 40 wt % of NaNO₂, and the composition was heated for 1 hour at 400° C. after being placed in a nickel crucible. The composition hardened after being taken out from an electric furnace was ground using an alumina mortar, and then the melting point and the freezing point were measured using a DSC.

TABLE 14

| | Melting | Melting | Freezing | Freezing |
|---|---|---|---|---|
| | Point 1 | Point 2 | Point 1 | Point 2 |
| HITEC | 90.0 | 142.1 | 141.9 | 126.2 |

(° C.)

### Comparative Example 3

### Preparation of Pentanary Composition

TABLE 15

| Sample | NaNO₃ | NaNO₂ | KNO₃ | KNO₂ | LiNO₃ |
|---|---|---|---|---|---|
| 5-5 | 0.1625 | 0.1625 | 0.1625 | 0.1625 | 0.3500 |

(mol %)

After mixing 50 g of raw material powder in a molar ratio of (5-5), the result was placed in a nickel crucible, melted by heating for 1 hour at 300° C., and then taken out at 200° C.

The coagulated molten salt composition was ground in an alumina mortar, and then the melting point and the freezing point were measured using a differential scanning calorimeter (DSC).

TABLE 16

| | Melting | Melting | Freezing | Freezing |
|---|---|---|---|---|
| Sample | Point 1 | Point 2 | Point 1 | Point 2 |
| 5-5 | 88.7 | 95.7 | 123.6 | 47.9 |

(° C.)

Thermal capacity of Solar Salt and HITEC that have been used in the art, and thermal capacity of (5-5) and (6-9) among the comparative examples and the examples of the present disclosure were measured using a DSC. It was seen that thermal capacity of the (6-9) composition prepared in the example of the present disclosure increased by 15% or greater compared to those of the Solar Salt and the HITEC.

TABLE 17

| | Solar Salt | HITEC | 5-5 | 6-9 |
|---|---|---|---|---|
| Thermal | 1.564 | 1.569 | 1.800 | 1.823 |
| Capacity | | | | |

(J/gK)

When examining Examples 1 to 6 and Comparative Examples 1, 2 and 3, it was seen that the melting points of Examples 1 to 6 including a hexanary composition were lower than the melting points of the comparative examples including binary, ternary and pentanary compositions. In addition, as for the thermal capacity, it was seen that the thermal capacities of Examples 1 to 6 were higher than the thermal capacities of the comparative examples including binary and ternary compositions, and therefore, Examples 1 to 6 exhibited excellent performance as a thermal storage material. Accordingly, it was observed that the thermal storage material including a hexanary composition at the same time had a significantly lower eutectic temperature, and exhibited higher efficiency as a thermal storage material.

Using the thermal storage material including a hexanary composition of the present disclosure may greatly enhance heat storage efficiency, and furthermore, is capable of providing a thermal storage material having high thermal capacity.

What is claimed is:

1. A thermal storage material comprising NaNO₃—NaNO₂—KNO₃—KNO₂—Ca(NO₃)₂—LiNO₃.

2. The thermal storage material of claim 1, wherein the Ca(NO₃)₂ is from 0.05 mol % to 0.1 mol %.

3. The thermal storage material of claim 1, wherein the NaNO₃ is from 0.1 mol % to 0.2 mol %, the Ca(NO₃)₂ is from 0.05 mol % to 0.4 mol % and the LiNO₃ is from 0.05 mol % to 0.5 mol %.

4. The thermal storage material of claim 1, wherein the NaNO₂ is from 0.1 mol % to 0.2 mol %, the Ca(NO₃)₂ is from 0.05 mol % to 0.4 mol % and the LiNO₃ is from 0.05 mol % to 0.5 mol %.

5. The thermal storage material of claim 1, wherein the KNO₃ is from 0.1 mol % to 0.2 mol %, the Ca(NO₃)₂ is from 0.05 mol % to 0.4 mol % and the LiNO₃ is from 0.05 mol % to 0.5 mol %.

6. The thermal storage material of claim 1, wherein the KNO₂ is from 0.1 mol % to 0.2 mol %, the Ca(NO₃)₂ is from 0.05 mol % to 0.4 mol % and the LiNO₃ is from 0.05 mol % to 0.5 mol %.

7. The thermal storage material of claim 1, wherein a molar ratio of the NaNO₃:NaNO₂:KNO₃:KNO₂:Ca(NO₃)₂:LiNO₃ is 1:1:1:1:0.2 to 0.5:0.8 to 2.2.

8. The thermal storage material of claim 1, wherein a sum of the Ca(NO₃)₂ and the LiNO₃ is from 1.3 mol to 2.7 mol with respect to 1 mol of the NaNO₃.

9. A solar heat storage system provided with the thermal storage material of claim 1.
